(19) United States
(12) Patent Application Publication
(10) Pub. No.: US 2010/0223099 A1
(43) Pub. Date: Sep. 2, 2010

(54) METHOD AND APPARATUS FOR A MULTI-DIMENSIONAL OFFER OPTIMIZATION (MDOO)

(76) Inventors: Eric Johnson, Longmont, CO (US); Don Kainer, Longmont, CO (US)

Correspondence Address: BROWNSTEIN HYATT FARBER SCHRECK, LLP, 410 SEVENTEENTH STREET, SUITE 2200, DENVER, CO, 80202, US

(21) Appl. No.: 12/634,423

(22) Filed: Dec. 9, 2009

Related U.S. Application Data
(60) Provisional application No. 61/201,441, filed on Dec. 10, 2008.

(51) Int. Cl. G06Q 10/00; G06Q 50/00; G06Q 30/00; G06F 15/18; G06N 5/02; G06N 3/08

(52) U.S. Cl. 705/10; 705/14.42; 706/12; 706/21; 706/25; 706/54

(57) ABSTRACT

A Multi-Dimensional Offer Optimization™ (MDOO) process is provided that may be defined generally as an offer simulation engine that matches an offer most likely to be accepted to the customer most likely to accept it. In general terms, the present offer simulation engine is defined as a form of predictive analytics used to make informed decisions about how to best spend scarce marketing dollars. Predictive analytics encompasses a variety of techniques from analytical statistics to traditional data mining that examines current and historical data to make predictions about future events. More specifically, the MDOO process uses predictive analytics to make decisions concerning customer optimization to include, by way of example, new customer acquisition, customer loyalty, customer retention and customer profitability.

### RELATED APPLICATIONS

This applications daims priority from U.S. Provisional Application No. 61/201,441, filed Dec. 10, 2008, which is hereby incorporated by reference.

### FIELD OF THE INVENTION

This invention relates, in general, to computer software, and more specifically to a method and apparatus for providing a computer implemented learning model of customer churn propensity.

### BACKGROUND

There are many reasons a customer terminates the services of a provider in highly competitive industries such as cell phone, cable television/satellite television or any similar highly competitive business having a volatile customer base. This customer “churn” is an important factor for any business with a subscriber-based service model as it may indicate customer dissatisfaction, cheaper or better offers from the competition, more successful sales and marketing by the competition, or reasons having to do with the customer life cycle. The present inventors have recognized the need for computer implemented methods for identifying the high risk customers (i.e., highly likely to churn), introducing offers intended on keeping them as subscribers, and outputting an indication of the effect the offer or multiple offers have on the subscriber's likelihood of terminating service prior to actually giving the subscriber a particular offer.

### BRIEF SUMMARY OF THE INVENTION

The present invention provides a computer implemented method for identifying the effect of one or more offers from a service provider on one or more of its customers. In one aspect, a list of high risk customers is received, defined as customers likely to churn, along with the associated high risk customer data. An original churn score is calculated from a plurality of variables. The plurality of variables are then manipulated based upon the one or more offers, resulting in the calculation of a new churn score. Finally, a computer file is populated with the list of high risk customers and each corresponding original churn score and each new churn score based upon the one or more offers. The specified aspects of the present invention may be more clearly understood by reviewing the embodiments and drawings.

### BRIEF DESCRIPT ON OF THE DRAWINGS

FIG. 1 illustrates one example of a computer environment in accordance with the present invention;

FIG. 2 is schematic view of the overall computer implemented MDOO process;

FIG. 3 illustrates the computer implemented process of the computer implemented) MDOO process in general;

FIG. 4 illustrates one example of the effect of provider offers on the subscriber's churn score in accordance with operating the MDOO model of the present invention;

FIG. 5 illustrates another example of the effect of provider offers on the subscriber's churn score in accordance with operating the MDOO model of the present invention;

FIG. 6 illustrates an example of the effect of multiple provider offers on the subscriber's churn score in accordance with operating the MDOO model of the present invention;

FIG. 7 illustrates another example of the effect of multiple provider offers on the subscriber's churn score in accordance with operating the MDOO model of the present invention; and

FIG. 8 is a flow chart in accordance with one embodiment of the computer implemented MDOO process of the present invention.

### BRIEF DESCRIPTION

In the following description, numerous specific details are set forth, such as examples of specific character lengths and character encoding schemes, in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

In one aspect of the present invention, a Multi-Dimensional Offer Optimization™ (MDOO) is provided that may be generally defined as an offer simulation engine that matches an offer most likely to be accepted to the customer most likely to accept it. This offer simulation engine may be used, for example, to retain customers, increase profitability or build brand loyalty to name a few. Each “dimension” of the offer can be tested to find a match. Such examples of a different dimension can include the cost, type or frequency of an offer.

In general terms, the offer simulation engine of the present invention is defined as a form of predictive analytics used to make informed decisions about how to best spend scarce marketing dollars. Predictive analytics encompasses a variety of techniques from analytical statistics to traditional data mining that examines current and historical data to make predictions about future events. Such predictions rarely take the form of absolute statements, and are more likely to be expressed as values that correspond to the odds of a particular event or behavior taking place in the future, in business, predictive models exploit patterns found in historical and transactional data to identify risks and opportunities. Models capture relationships among many factors to allow assessment of risk or potential associated with a particular set of conditions, guiding decision making for candidate transactions,

More specifically, the MDOO process of the present invention uses predictive analytics to make decisions concerning customer optimization. Customer optimization in this sense is meant to include, by way of example, new customer acquisition, customer loyalty, customer retention and customer profitability. With the amount of competing services available in industries such as mobile phones, cable television/satellite television and the like—where changing to a competitor product/service is relatively easy and the customer base is the source for most if not all revenue—it serves a company well to focus efforts on maintaining continuous consumer satisfaction. More specifically, in competitive industries, consumer loyalty must be rewarded and customer attrition ought to be minimized. Today, instead of being proactive and identifying targeted high risk customers that may terminate service, businesses tend to be purely reactionary and respond to customer attrition only after the customer is in the process of actually terminating service. At this stage of the customer's life cycle, for a host of reasons, the possibility of reversing the customer's decision to terminate service—and in most cases, activate service with a competitor—is next to impossible, Accordingly, the proper application and use of predictive analytics can lead to a more proactive retention strategy. By a frequent examination of a customer's past service usage, service performance, spending and other behavior patterns, predictive models can determine the likelihood of a customer choosing to terminate service sometime in the near future. An intervention with the correct offer as determined by the MDOO process extended to the customer early on can significantly increase the chance of retaining the customer.

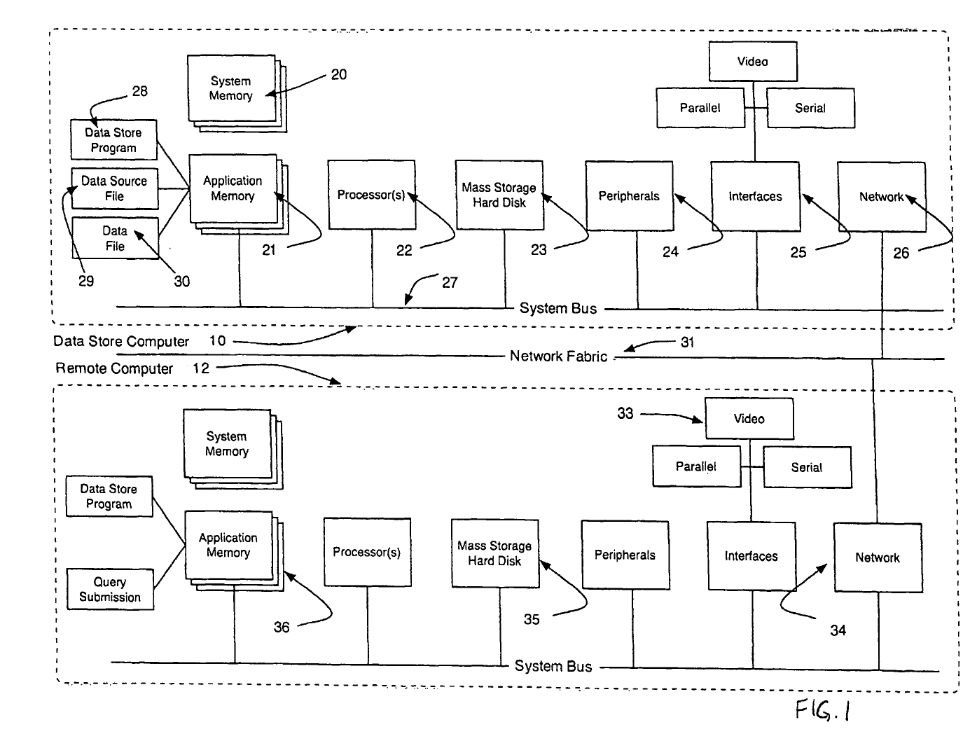

Example embodiments of an MDOO offer simulation engine of the present invention will be illustrated by the drawings and corresponding explanation. FIG. 1 is an example environment includes two computing devices 10, 12 illustrated as a personal computer. FIG, 1 represents a typical operating environment for implementing the present invention, however, as one of skill in the art can appreciate, there are an infinite number of ways to implement the present invention without departing from the intended scope and spirit, For example, any number of combinations of database elements and server elements may replace the items shown. Therefore, the illustrated environment in FIG. 1 is in no way limiting.

Personal computer 10 comprises system memory 20 and application memory 21, a processing core including one or more processors, access to mass storage 23, peripherals 24, interfaces 25 and commonly a network access device 26. Each item of the personal computer system is coupled to a system bus 27 for allowing coordinated communication between all of the components. This first computer 10 would be the home of the data store software and program files 28. Although this is an exemplary setup, those skilled in the art will readily recognize that there are many permutations of this simplified set up including, but not limited to, wireless network, removable storage devices, solid state media devices, processing farms, multi processing cores, various memory enhancements, and improvements on the basic interfaces like USB, Firewire, SATA, SCSI to name a few. A number of programs may be stored on the main storage hard disk 23 and then loaded into memory for execution 21. The data store implements routines, sub-routines, objects, programs, procedures, components, data structures and other necessary aspects that comprise the data store program 28. The data store program works with the data source file 29 and data file 30 to create, delete or manipulate data.

Through the network fabric 31, computers are able to talk to each other using protocols such as TCP/IP and media choices including Ethernet. Those skilled in the art will understand that there are many permutations of this network fabric and the chosen network fabric is not intended to be limiting in any way. Accordingly, the present invention is capable of running on any of those permutations.

A user or another software program may input queries through the remote computing environment 12 using various input devices connected to the interfaces like, but not limited to, a mouse, keyboard, keypad, microphone or touch screen. A display device is often connected to the system 33 to handle visual interaction with the user, but the present invention is capable of running without a visual interface by use of a program or module or subroutine, or an audio interface to handle the input. The remote computer is often connected to the network through network interface or adapter 34, but could be connected wirelessly, through a modem or directly coupled to the computer running the data store. Those skilled in the art will appreciate that this is exemplary and the present invention will perform over a multitude of communication links. The remote computer 12 runs some portion of the program module loaded from hard disk 35 into application memory 36. The present invention can be implemented in any division of client and server workload and this illustration serves only to be an example.

Additionally, those skilled in the art will appreciate that the present invention is capable of being implemented in many other configurations including, but not limited to, terminals connected to host servers, hand held devices, mobile devices, consumer consoles, special purpose machines to name a few.

In one embodiment, the present invention utilizes a variation of advanced Artificial Neural Networks (ANN) to model complex customer optimization in accordance with the present invention. In practice, neural networks are nonlinear sophisticated modeling techniques that are able to model complex functions. More specifically, an ANN is an interconnected group of artificial neurons that use a mathematical or computational model for information processing based on a connectionistic approach to computation. In most cases, an ANN is an adaptive system that changes its structure based on external or internal information that flows through the network. In modern software implementations of artificial Neural Networks, the approach inspired by biology has more or less been abandoned for a more practical approach based on statistics and signal processing. Artificial Neural Networks can be applied to problems of prediction, classification or control in a wide spectrum of fields such as finance, telecommunications, retail and demographics to name a few.

Neural networks are used when the exact nature of the relationship between inputs and output is not known. A key feature of neural networks is that they learn the relationship between inputs and output through training. In this regard, there are two types of training in neural networks used by different networks, supervised and unsupervised training. Supervised learning is a machine learning technique for learning a function from training data. The training data consist of rows of input objects (typically vectors), and desired outputs. Unsupervised learning is a class of problems in which one seeks to determine how the data is organized. It is distinguished from supervised learning in that the learner is given only unlabeled examples. Unsupervised learning is closely related to the problem of density estimation in statistics. However, unsupervised learning also encompasses many other techniques, such as clustering, that seek to summarize and explain key dimensions of the data. Some examples of neural network training techniques include, but are in no way limited to, back propagation, quick propagation, conjugate gradient descent, projection operator and Delta-Bar-Delta, which are applied to network architectures such as multilayer perceptrons, Kohonen networks and Hopfield networks to name a few.

Neural networks, with their ability to derive meaning from complicated or imprecise data, can be used to extract patterns and detect trends that are too complex to be noticed by either humans or other computer techniques. A trained neural network can be thought of as an “expert” in the category of information it has been given to analyze. This expert can then be utilized to provide projections given new situations of interest and answer “what if” questions. Neural networks also have the following additional advantages: adaptive learning—an ability to learn how to do tasks based on the data given for training or initial experience; self-organization—an ANN can create its own organization or representation of the information it receives during learning time; real time operation—ANN computations may be carried out in parallel, thus allowing massive computational “threads;” and fault tolerance via redundant information coding—partial destruction of a network leads to the corresponding degradation of performance, however, some network capabilities may be retained even with major network damage.

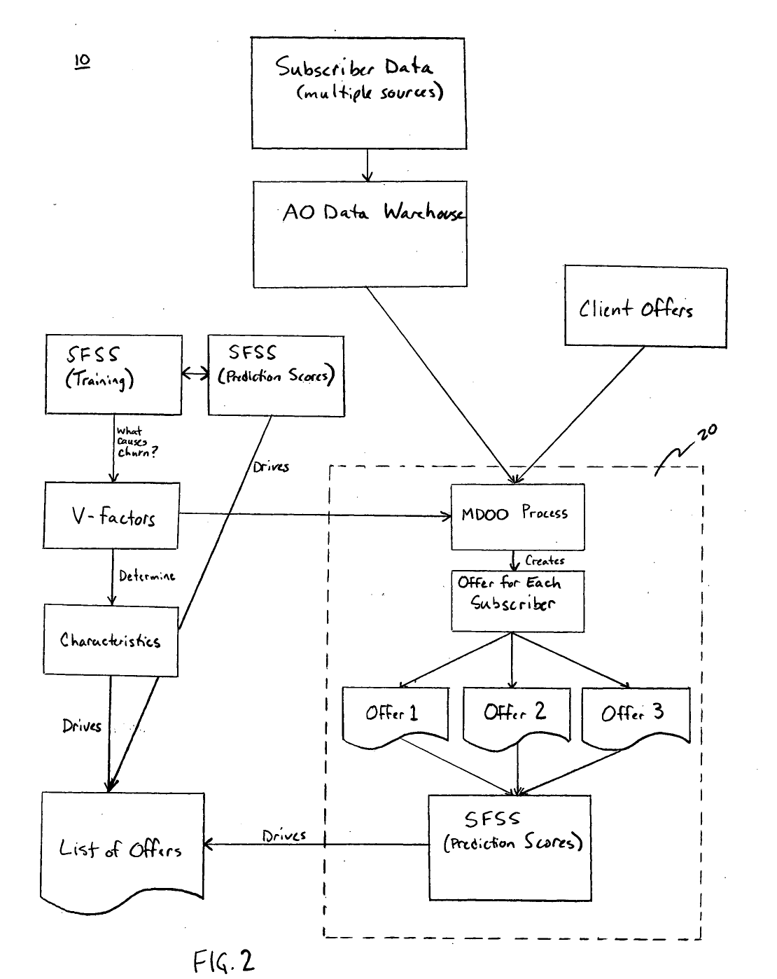

One example of an MDOO process, as shown in FIG. 2, uses the technology to help target companies retain their subscribers by focused relevant retention offers. In the illustrated embodiment, a process 10 transforms data into unique variables representing a subscriber's behavior. This illustrated process starts by receiving data from the target company about their subscribers. The target company data may include a list of former subscribers who left or terminated service and current subscribers who have not left yet or are active in the service. Examples of relevant sub-classifications of data include: subscriber account data, billing and payment data, usage data, customer care and demographic to name a few. In the example illustrated, process 10 merges and aligns that data from multiple sources and creates a modeling object called a standard form spreadsheet (SFSS) which is used to train a model. The SFSS contains important subscriber information that gives details about the characteristics of the subscriber. In the embodiment of FIG. 2, this particular SFSS is called the training spreadsheet because the information is analyzed to determine which variables lead to subscriber attrition, that is, the characteristics that influence churn. V-Factors are defined in process 10 as variables that are significant to subscriber churn.

The analysis of V-Factors begins with the investigation to determine the drivers of churn and their level of influence (positively or negatively) in the churn model. If specific variables contribute significantly to churn (positively or negatively), then offers built using those variables can be used to influence churn behavior. The superset of V-Factors identified defines the characteristics that influence churn. These characteristics drive the identification of offers to be given to the subscribers who are likely to leave and terminate service. An example of a V-Factor might be a particular high end customer service plan. Using this V-Factor, the process can examine both subscribers that have this customer service plan and subscribers who do not have the plan. The customers who have the customer service plan were less likely to churn than the customers who did not have the plan. Therefore, the customer service plan has a significant effect on churn, making it a V-Factor. In this example, it might be desirable to determine the affect of offering people who don't have this customer service plan a free three month trial of service and see how it affects the customer's propensity to churn. Along with other possible V-Factors, any offer can be analyzed to determine their ability to reduce each subscriber's chance of churn. In the illustrated embodiment, using the trained model (SFSS Training) and V-Factor analysis, the target company is given a complete view of the factors driving churn in their customer population and consequently what offers are most likely to be accepted.

To implement an MDOO simulation, information from the SFSS (training) is put into a series of spreadsheets called the SFSS (prediction) score spreadsheets. One spreadsheet contains the original customer data. The remaining (n−1) spreadsheets contain data that is altered to simulate the acceptance of each of the (n−1) offers. Based on the trained model, a raw score is computed using the data in the unaltered SFSS. The raw scores are ranked by highest raw score to the lowest raw score to determine the subscribers that are highly likely to leave. Once the characteristics that affect churn behavior are known, and offers that affect those characteristics are determined, the MDOO can simulate the affect the offers have on churn behavior. In one embodiment, the MDOO runs (n−1) score cycles and compares the difference in the scores. This simulation enables a determination of the offers that have the greatest impact on churn, i.e., the offer that lowered the subscriber churn score the most.

MDOO process 20 of FIG. 2 is a computer implemented offer simulation engine which matches the offer most likely to be accepted by a customer. In the illustrated example, the purpose of MDOO process 20 is to literally ask the question, “Which offer would be most effective in saving this particular subscriber?” The effect of the offer is positive if the resulting churn score is lowered and vice versa. The same model that is used to generate predictions is used to predict the effect on churn of various interventions. In one embodiment, an aspect of the invention explores all possible interventions as determined by quantitative analysis. For each intervention, a reduction in churn probability may be computed, and then an intervention is chosen that leads to the greatest reduction in probability. If different interventions have different costs, decision-theoretic techniques may be used to choose the intervention that yields the greatest savings to the carrier.

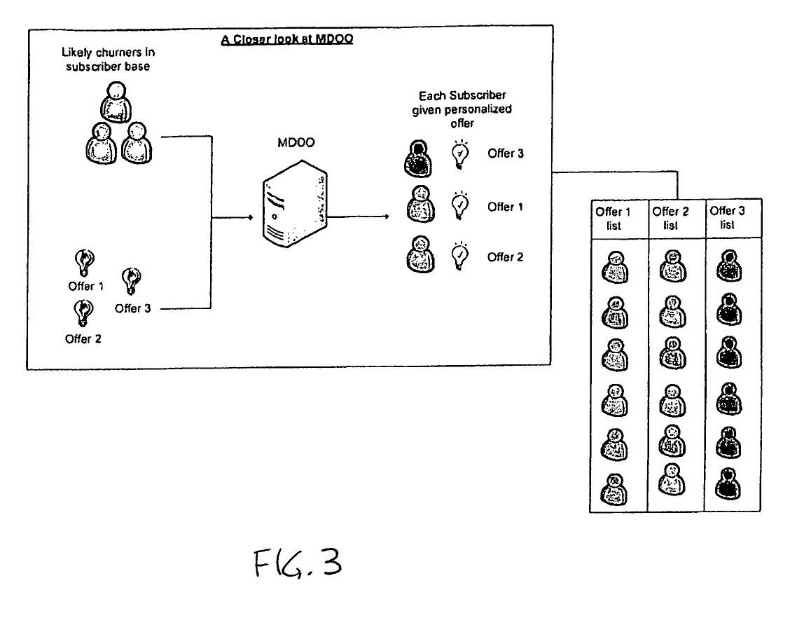

FIG. 3 illustrates the process of the MDOO in general according to one embodiment of the invention and focuses on the actual input of customers and offers into the computer implemented MDOO neural network. The identified subscribers that have a propensity to churn and the designated offers are shown on the left side of the computer implemented MDOO process. The computer implemented process of the MDOO receives the requisite inputs, performs a calculation and outputs the subscriber matched with a particular offer that is chosen so as to reduce the likelihood of churning, as shown on the right side of the computer implemented MDOO process. Accordingly, the computer implemented MDOO process matches individual customers with an offer that reduces their churn score the most. After receiving an offer, each high risk subscriber is then sorted into lists that include the same offers of other subscribers. Sorting into larger groups allows a provider to easily and efficiently send out unique offers to a large number of people.

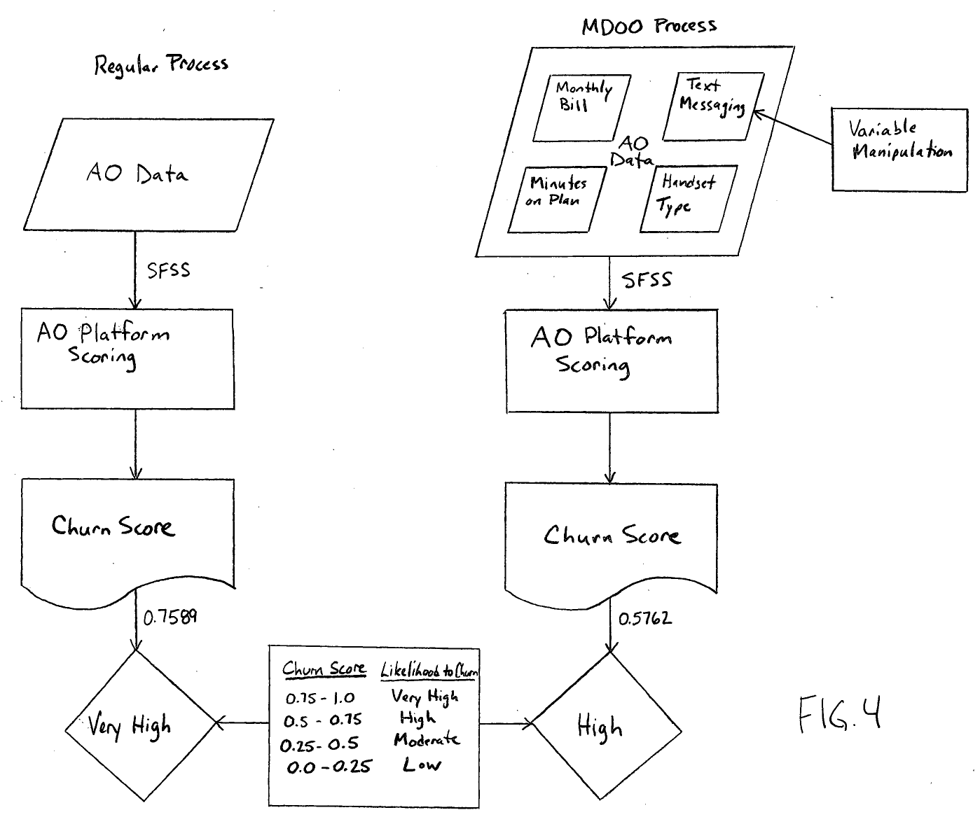

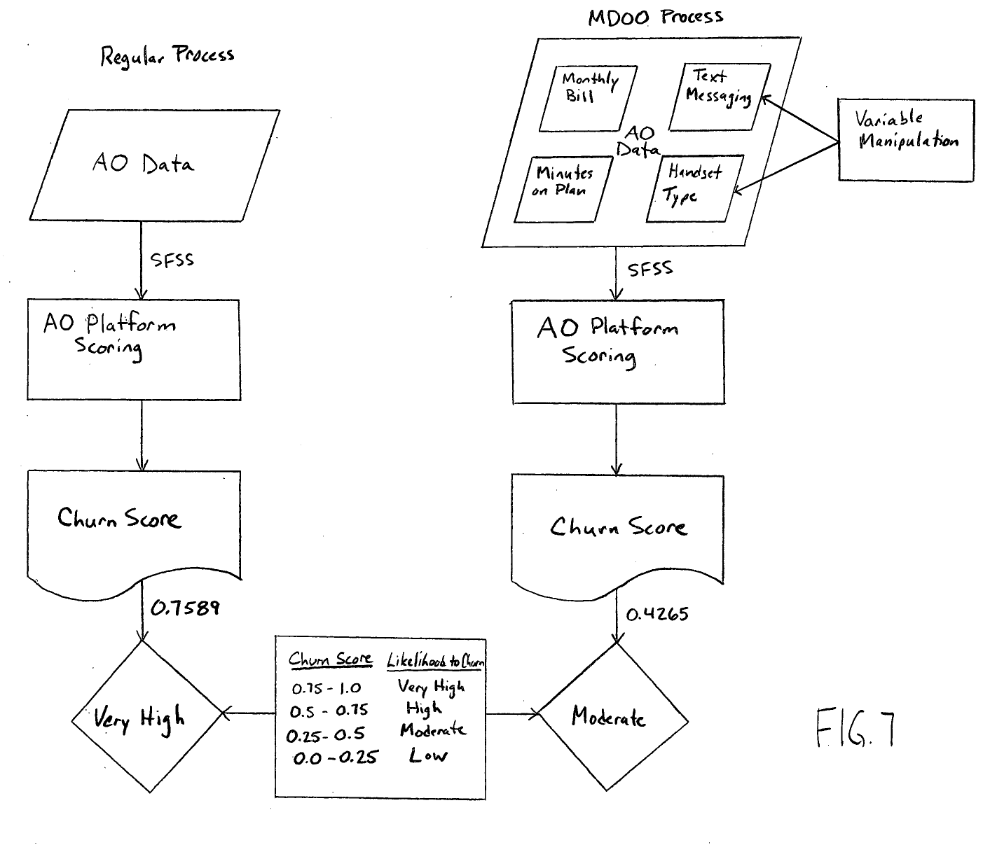

FIGS. 4-7 illustrate various examples that show the effect on the churn score when certain variables are manipulated, i.e., certain offers are introduced to the computer implemented MDOO model. For example, in FIG. 4, the initial churn score for the illustrated subscriber is 0.7589. An offer is introduced that changes the text messaging portion of the subscriber's plan, such as providing additional free text messages or unlimited text messages. The model of the MDOO is then run, which produces the new churn score of 0.5672. In the illustrated example, the offer of increased or unlimited text messages to this particular subscriber has moved the likelihood of this customer churning from “very high” to “high.” The same variable manipulation can be performed for each identified high risk subscriber, i.e., a subscriber that is likely to terminate service. This type of information is valuable to a provider so as to target an offer to the particular subscribers it will most likely effect, rather than sending it to everyone and having it impact a much smaller segment of the high risk subscribers identified.

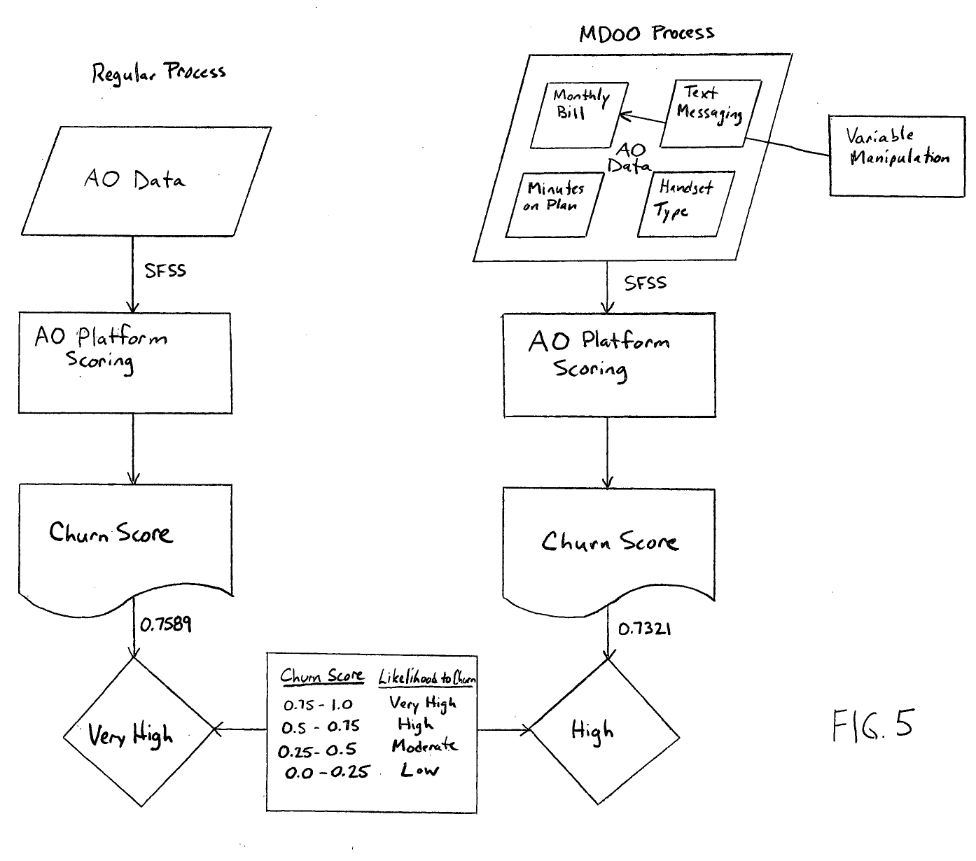

Continuing with the example in FIG. 5, the initial churn score for the illustrated subscriber is 0.7589. An offer is introduced that affects the monthly bill, for example, giving a $20 credit or a free month of service. The model of the MDOO is then run, which produces the new churn score of 0.7321. in the illustrated example, the monthly bill offer has moved the likelihood of this customer churning from “very high” to “high,” however the new churn score is still on the upper end of the high score. In this example, the monthly bill offer has an effect on the original churn score, but does not have as significant of an effect as the text messaging offer in the example of FIG. 4.

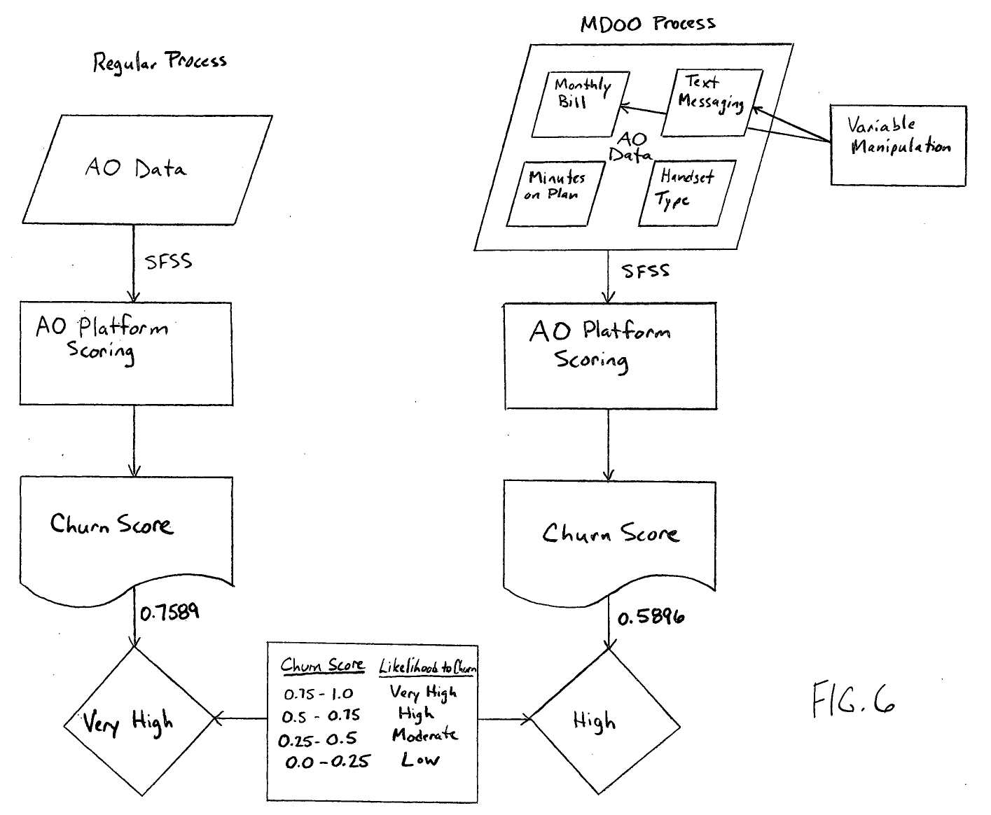

In the example illustrated in FIG. 6, the initial churn score for the illustrated subscriber is again 0.7589. What makes the neural network of the present invention multi-dimensional is the ability to manipulate two or more variables at the same time such that the computer implemented MDOO neural network works can determine what the resulting churn score would be if a number of different variables were to be changed. An offer is introduced that effects both the text messaging, as shown in FIG. 4, and the fees charged for services, for example, a break on the fees owed and allowed them a certain number of time per month with free text messaging. The model of the MDOO is then run, which produces the new churn score of 0.5896. in the illustrated example, the combined text messaging/fees offer has moved the likelihood of this customer churning from “very high” to “high,” similar to the example of FIG. 4. However, in this example, the combined offer does not have as significant of an effect as the text messaging offer in the example of FIG. 4. Again, this information is very valuable to the services provider, since it is unnecessary to provide both offers to this particular subscriber to achieve a lower churn score.

In the example illustrated in FIG, 7, the initial churn score for the illustrated subscriber is again 0.7589. An offer is introduced that effects both the text messaging, as shown in FIG. 4 and FIG. 6, and the customer's handset, for example, a free upgrade to a newer model. The model of the MDOO is then run, which produces the new churn score of 0.4265. In the illustrated example, the combined text messaging/handset offer has moved the likelihood of this customer churning from “very high” to “moderate,” a significant improvement over the previous examples. Again, this information is very valuable to the services provider, since the combined offer of text messaging and a new handset achieves a significantly lower churn score than the previous three examples illustrated in FIGS. 4-6.

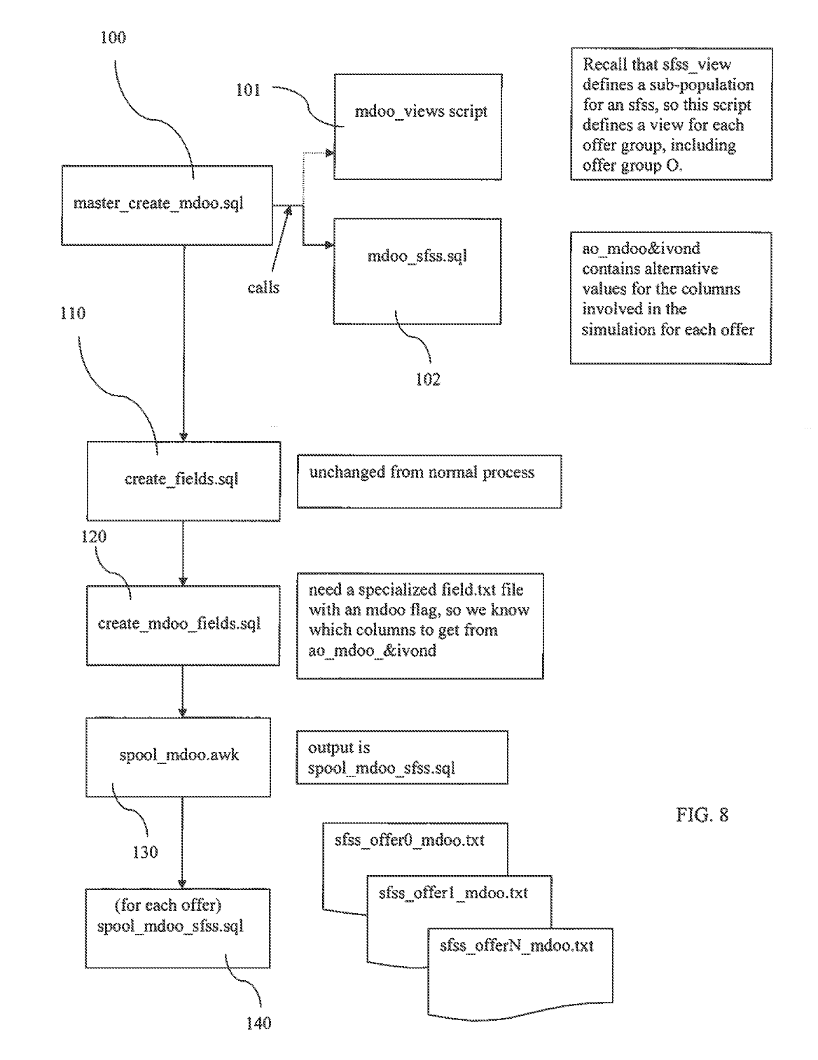

The flow chart illustrated in FIG. 8 shows a representative technical implementation of the MDOO process, as the computer implementation in general differs from the regular spreadsheet generation process. A master_create_mdoo object 100 will create both a view and a database standard form spreadsheet (sfss) which represent the individuals eligible for a given offer, mdoo_views 101, and the altered data simulating the offers, mdoo_sfss 102. These altered data fields are then recognized by create_mdoo_fields 120 so that they are injected into the spreadsheet generated at spool_mdoo 130. This produces multiple copies of spool_mdoo_sfss 140, one for each offer, which then generate the data files to be given to our platform for scoring. These data files that the platform scores now differ from the original raw data file solely by the manipulations made to simulate a given offer.

In the illustrated embodiment, in the final step in the MDOO process, the final score file is generated and delivered to the customer. This score file has different characteristics based on the customer's method of contact with their subscribers. Methods may include telephone, direct mail, email, etc. The score file will minimally contain a key to identify the subscriber (usually an account number) and the best offer for each subscriber. Other fields may include a phone number (if the contact is by phone), or an email address (if the contact is by email). All of this additional data is obtained from the AO data warehouse. The master list can then be divided into subsidiary or “sub” lists, one for each offer. For example, there is a sub list of people who are offered $10 off their total bill, another sub list of people who are given unlimited texts for three months, and another sub list of people who are given 100 free minutes to name but a few. This enables the customer to organize offers into groups so that deploying the offers is straight forward. The computer implemented MDOO process may tailor a complete retention solution, not only in terms of churn-likelihood of a subscriber (churn scores), but also providing the retention offers that have the best quantitative affect on reducing churn-likelihood for that subscriber.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment.

It should also be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. Inventive aspects lie in less than all features of a single foregoing disclosed embodiment, and each embodiment described herein may contain more than one inventive feature.

While the invention has been particularly shown and described with reference to embodiments thereof, it will be understood by those skilled in the art that various other changes in the form and details may be made without departing from the spirit and scope of the invention.

We claim:

1. A computer implemented method for identifying the effect of one or more offers from a service provider on one or more of its customers, the method comprising;
receiving a list of high risk customers, defined as customers likely to churn, and associated high risk customer data;
calculating an original churn score from a plurality of variables;
manipulating the plurality of variables based upon the one or more offers;
calculating a new churn score; and
populating a computer file with the list of high risk customers and each corresponding original churn score and each new churn score based upon the one or more offers.

2. The computer implemented method of claim of claim 1, wherein the service provider is a reoccurring subscriber based company.

3. The computer implemented method of claim of claim 1, wherein the customer data further comprises subscriber account data.

4. The computer implemented method of claim 3, wherein the subscriber account data is one or more chosen from the group consisting of billing and payment data, voice analytical data, usage data, customer care data, demographic data, customer infrastructure data, and customer relationship management (CRM) data.

5. The computer implemented method of claim of claim 1, wherein the step of manipulating the plurality of variables is performed by computer implemented modeling techniques that are able to model complex functions.

6. The computer implemented method of claim of claim 5, wherein the modeling technique is a machine learning technique.

7. The computer implemented method of claim of claim 6, wherein the modeling technique is chosen from the group consisting of an advanced Artificial Neural Network (ANN), support vector machines, decision tree algorithms, and clustering techniques.

8. The computer implemented method of claim of claim 7, further comprising creating a modeling object from a standard form spreadsheet (SFSS) by training an ANN, and by analyzing the information in said modeling object to determine which variables lead to subscriber attrition.

9. The computer implemented method of claim of claim 8, wherein said variables are V-factors.

10. The computer implemented method of claim of claim 1, further comprising transforming customer data into the plurality of variables representing a subscriber's behavior.
